(19) United States
(12) Patent Application Publication
(10) Pub. No.: US 2023/0140644 A1
(43) Pub. Date: May 4, 2023

(54) A SPACECRAFT ATTITUDE CONTROL SYSTEM AND A SPACECRAFT COMPRISING SUCH AN ATTITUDE CONTROL SYSTEM

(71) Applicant: SPACE TALOS LIMITED, London (GB)

(72) Inventors: Alexandros Christou, London (GB); Majed Abdel Jawad, London (GB)

(73) Assignee: SPACE TALOS LIMITED, London (GB)

(21) Appl. No.: 17/766,241

(22) PCT Filed: Sep. 21, 2020
(86) PCT No.: PCT/GB2020/052280

§ 371 Date: Apr. 2, 2022

(30) Foreign Application Priority Data
Oct. 3, 2019 (GB) 1914301.5

(51) Int. Cl. B64G 1/24; B64G 1/54

(52) U.S. Cl. CPC B64G 1/244; B64G 1/54

(57) ABSTRACT

A: spacecraft attitude control system comprising •at least one attitude control device (2), the attitude control device comprising •first and second magnets (3, 4) having magnetic dipole moments M1 and M2 respectively, each magnet (3, 4) comprising a north pole face and a south pole face; •the magnets (3, 4) being spaced apart along a length axis by a gap, •for each magnet the pole face closest to the other magnet being termed the closest face, the magnets being arranged with the closest faces being of the same pole; •the first magnet 3 being connected to a rotation mechanism (7), the rotation mechanism being adapted to rotate the first magnet about first and second axes (8, 9), none of the first axis (8), second axis (9) and magnetic dipole moment M1, M2 of the first magnet (3) being parallel to the other.

The present invention relates to a spacecraft attitude control system. More particularly, but not exclusively, the present invention relates to a spacecraft attitude control system comprising at least one spacecraft attitude control device, the spacecraft attitude control device comprising first and second magnets having magnetic moments extending in opposite directions, at least one of the magnets being connected to a rotation mechanism adapted to rotate the magnet about first and second non parallel axes. More particularly, but not exclusively, the present invention also relates to a spacecraft attitude control system comprising at least one spacecraft attitude control device, the spacecraft attitude control device comprising first and second magnets, the first magnet being connected to a first rotation mechanism for rotating the first magnet about a first axis and the second magnet being connected to a second rotation mechanism for rotating the second magnet about a second axis, the first axis and second axis not being parallel.

Spacecraft such as satellites often include magnetic components. Such magnetic components can include magnets having a dipole moment used to correctly orient the spacecraft in the earth's magnetic field. Such magnetic components can also include shield magnets which are arranged to divert ionising radiation away from the spacecraft. All such magnetic components produce a magnetic field which surrounds the spacecraft.

If the spacecraft experiences an external magnetic field, for example at a plasma shock barrier, then this external field will alter the shape of the magnetic field surrounding the spacecraft. This can produce an unwanted magnetic dipole moment and hence an unwanted torque on the spacecraft. A similar problem can arise if the magnetic components are misaligned which may only become apparent after launch.

The present invention seeks to overcome the problems of the prior art.

Accordingly, in a first aspect, the present invention provides a spacecraft attitude control system comprising
at least one attitude control device, the at least one attitude control device comprising
   first and second magnets having magnetic dipole moments M1 and M2 respectively, each magnet comprising a north pole face and a south pole face;
   the magnets being spaced apart along a length axis by a gap,
   for each magnet the pole face closest to the other magnet being termed the closest face, the magnets being arranged with the closest faces being of the same pole;
   the first magnet being connected to a rotation mechanism, the rotation mechanism being adapted to rotate the first magnet about first and second axes, none of the first axis, second axis and magnetic dipole moment of the first magnet being parallel to the other.

The spacecraft attitude control system according to the invention is able to produce a magnetic torque which can correct for the effects of an external magnetic field or misalignment of the magnetic components.

Preferably the magnitude of M1 is equal to the magnitude of M2.

Preferably for each magnet the angle between its magnetic dipole moment and the length axis is less than 25 degrees, more preferably less than 15 degrees, more preferably less than 10 degrees.

Preferably the first and second axes, are normal to each other.

Preferably the first and second axes lie in a plane normal to the length axis.

Preferably the rotation mechanism comprises a dual axis gimbal mechanism.

Alternatively the rotation mechanism comprises a support plate spaced apart from the first magnet and a plurality of spaced apart linear actuators extending between the first magnet and support plate.

Alternatively, the rotation mechanism comprises

a support plate, the magnet being pivotally connected to the support plate;

the support plate being adapted to rotate about the second axis;

the rotation mechanism further comprising at least one linear actuator extending between the support plate and magnet and spaced apart from the pivot, the at least one linear actuator being arranged such that extension or contraction of the linear actuator causes the magnet to pivot at the pivot and so rotate about the first axis.

Preferably the support plate lies in a plane substantially normal to the length axis and the second axis extends along the length axis.

Alternatively, the support plate lies in a plane inclined to the length axis and the second axis is inclined to the length axis.

Preferably at least one linear actuator is a piezoelectric linear actuator.

Preferably the second magnet is held in fixed relation to the length axis.

Preferably the magnetic moment M2 of the second magnet extends along the length axis.

Alternatively, the second magnet is connected to a second rotation mechanism, the second rotation mechanism being adapted to rotate the second magnet about third and fourth axes, none of the third axis, fourth axis and magnetic moment of the second magnet being parallel.

Alternatively, the second magnet is connected to a second rotation mechanism, the second rotation mechanism being adapted to rotate the second magnet about a single axis only.

Preferably the spacecraft attitude control system further comprises a magnetometer adapted to measure a magnetic field; and,

a controller connected to the magnetometer and at least one rotation mechanism and adapted to control the orientation of the at least one rotation mechanism in response to the magnetic field measured by the magnetometer.

Preferably at least one magnet is a rod.

Preferably at least one magnet is a disk.

Preferably the spacecraft attitude control system further comprises a radiation shield surrounding the first and second magnets.

Preferably the radiation shield comprises a plurality, of shield magnets arranged in a magnetic multipole such that in the absence of an external magnetic field the shield magnets provide no overall dipole moment.

In a further aspect of the invention there is provided a spacecraft attitude control system comprising
at least one attitude control device, the attitude control device comprising
   first and second magnets having magnetic dipole moments M1 and M2 respectively, each magnet comprising a north pole face and a south pole face;
   the magnets being spaced apart along a length axis by a gap;
   for each magnet the pole face closest to the other magnet being termed the closest face, the magnets being arranged with the closest faces being of the same pole;
   the first magnet being connected to a first rotation mechanism, the first rotation mechanism being adapted to rotate the first magnet about a first axis not parallel to the first magnetic moment;
   the second magnet being connected to a second rotation mechanism, the second rotation mechanism being adapted to rotate the second magnet about a second axis not parallel to the second magnetic moment;
   the first axis being not parallel to the second axis when viewed along the length axis.

Preferably the first and second axes lie in parallel planes.

Preferably the parallel planes are normal to the length axis.

Preferably the first and second axes are normal to each other when viewed along the length axis.

Preferably the magnitude of M1 is equal to the magnitude of M2.

Preferably for each magnet the angle between its magnetic dipole moment and the length axis is less than 25 degrees, more preferably less than 15 degrees, more preferably less than 10 degrees.

Preferably at least one rotation mechanism comprises a gimbal mechanism, preferably a single axis gimbal mechanism.

Preferably at least one rotation mechanism comprises an axle adapted to rotate about one axis only.

Preferably at least one rotation mechanism comprises a support plate spaced apart from its associated magnet and a plurality of spaced apart linear actuators extending between the magnet and support plate.

Preferably at least one rotation mechanism comprises a support plate, the associated magnet being pivotally connected to the support plate;

the rotation mechanism further comprising at least one linear actuator extending between the support plate and magnet and spaced apart from the pivot, the linear actuator being arranged such that extension or contraction of the linear actuator causes the magnet to pivot about the pivot.

Preferably at least one linear actuator is a piezoelectric actuator.

Preferably the spacecraft attitude control system as further comprises a magnetometer adapted to measure a magnetic field; and,

a controller connected to the magnetometer and the rotation mechanisms and adapted to control the orientation of the rotation mechanisms in response to the magnetic field measured by the magnetometer.

Preferably at least one magnet is a rod.

Preferably at least one magnet is a disk.

Preferably the spacecraft attitude control system further comprises a radiation shield surrounding the first and second magnets.

Preferably the radiation shield comprises a plurality of shield magnets arranged in a magnetic multipole such that in the absence of an external magnetic field the shield magnets provide no overall dipole moment.

Preferably the spacecraft attitude control system comprises a plurality of attitude control devices, the length axis of at least one attitude control device being inclined, preferably normal, to the length axis of at least one other attitude control device.

Preferably the spacecraft attitude control system comprises first and second attitude control devices, the length axis of one being normal to the length axis of the other.

In a further aspect of the invention there is provided a spacecraft comprising a spacecraft attitude control system as claimed in any one of claims 1 to 38.

Preferably the spacecraft is a satellite.

The present invention will now be described by way of example only and not in any limitative sense with reference to the accompanying drawings in which

FIG. 1 shows, in schematic form, a first embodiment of a spacecraft attitude control system according to the invention;

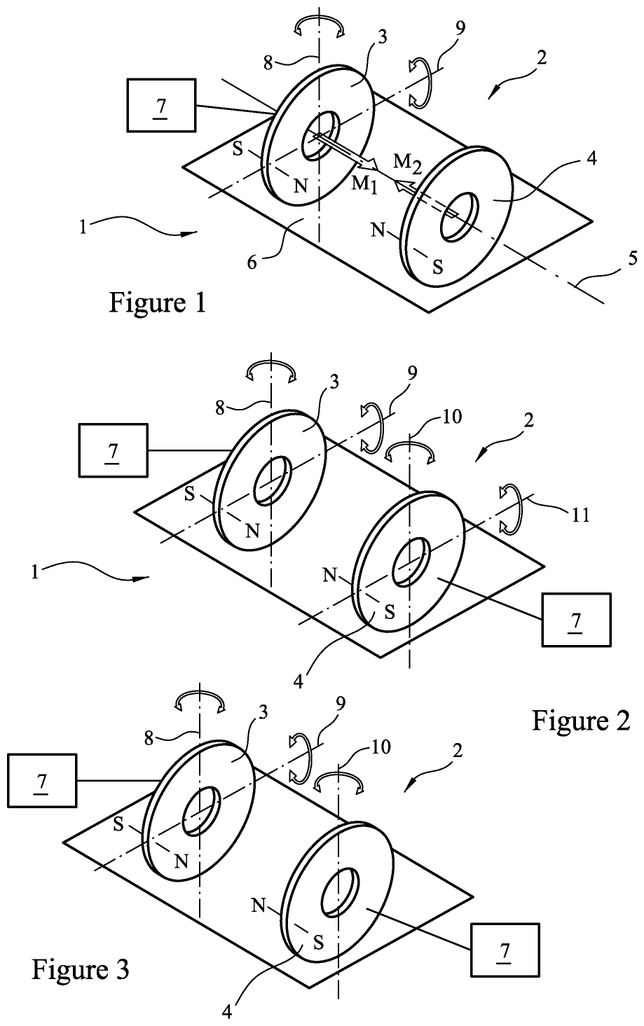

FIG. 2 shows a further embodiment of a spacecraft attitude control system according to the invention;

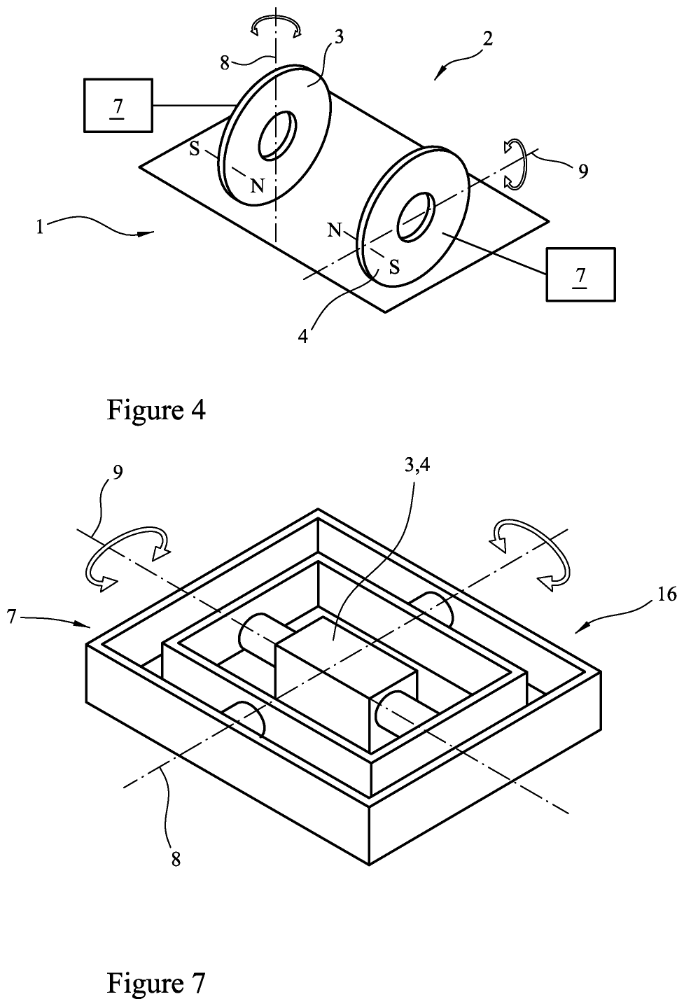

FIG. 3 shows a further embodiment of a spacecraft attitude control system according to the invention;

FIG. 4 shows a further embodiment of a spacecraft attitude control system according to the invention;

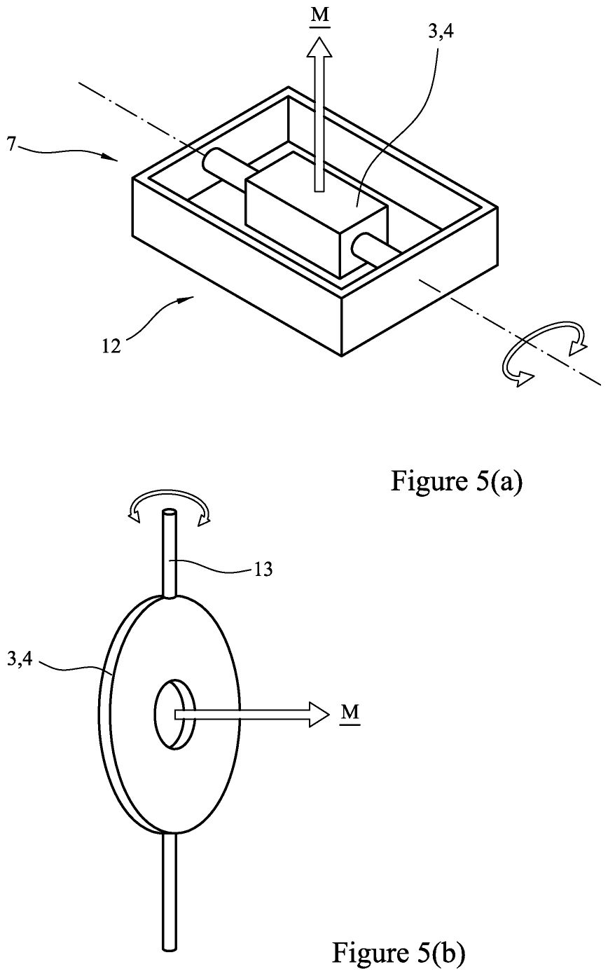

FIGS. 5(a) and 5(b) show a first embodiment of a rotation mechanism for use with a spacecraft attitude control system according to the invention and a variant thereof;

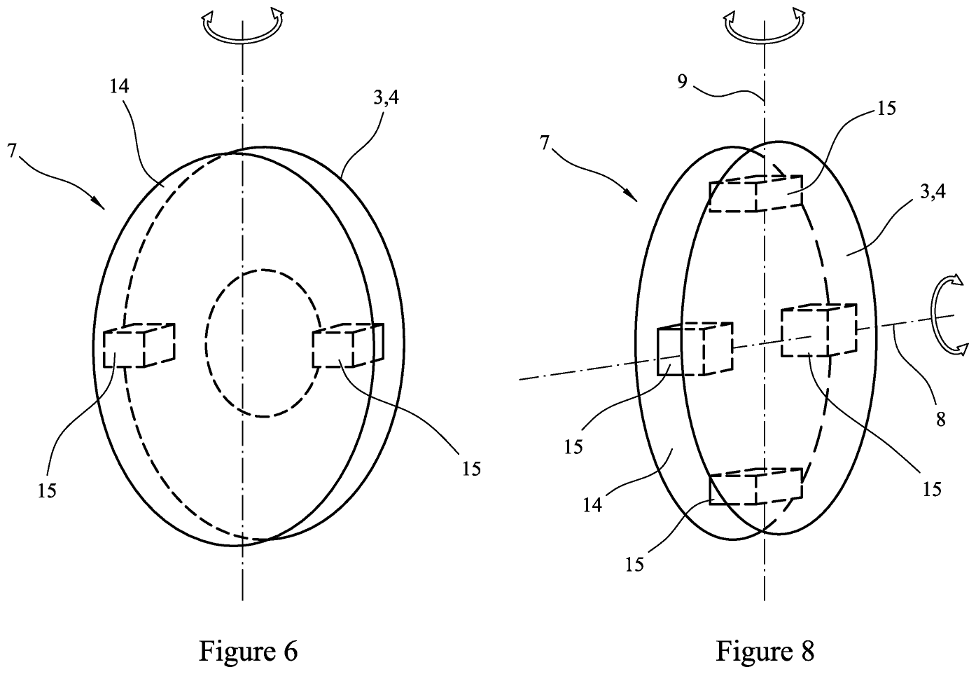

FIG. 6 shows a further embodiment of a rotation mechanism for use with a spacecraft attitude control system according to the invention;

FIG. 7 shows a further embodiment of a rotation mechanism for use with a spacecraft attitude control system according to the invention;

FIG. 8 shows a further embodiment of a rotation mechanism for use with a spacecraft attitude control system according to the invention;

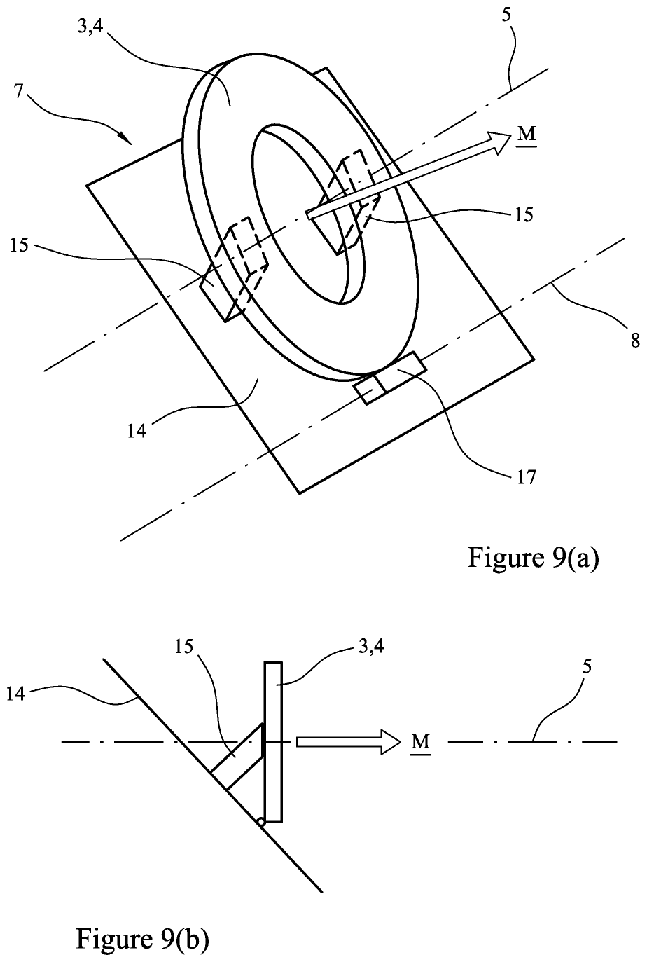

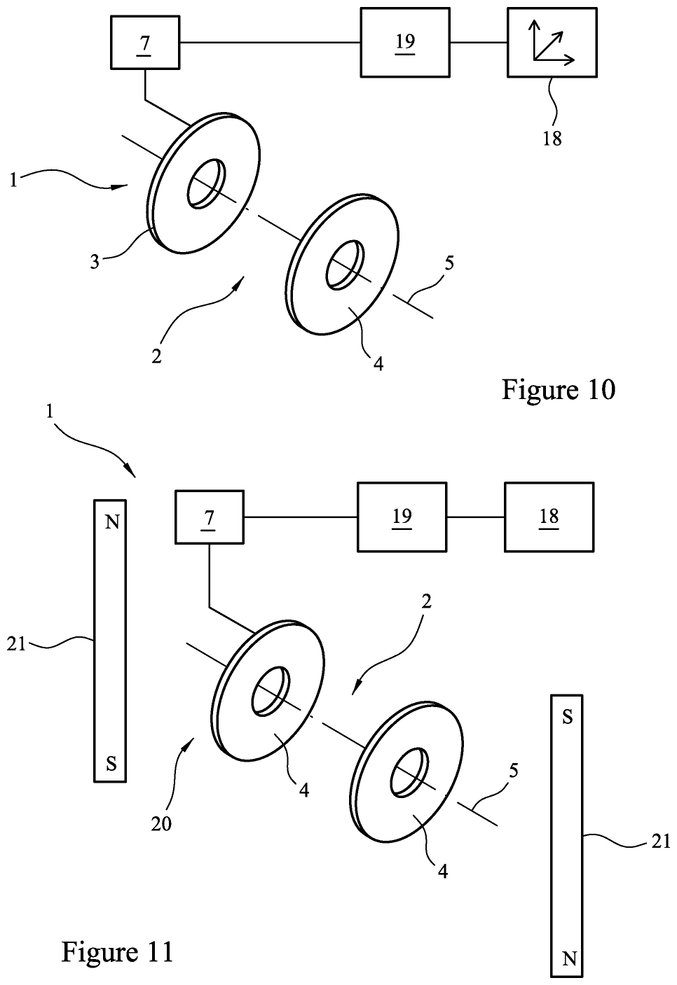

FIGS. 9(a) and 9(b) show further embodiments of a rotation mechanism for use with a spacecraft attitude control system according to the invention;

FIG. 10 shows a further embodiment of a spacecraft attitude control system according to the invention;

FIG. 11 shows a further embodiment of a spacecraft attitude control system according to the invention; and,

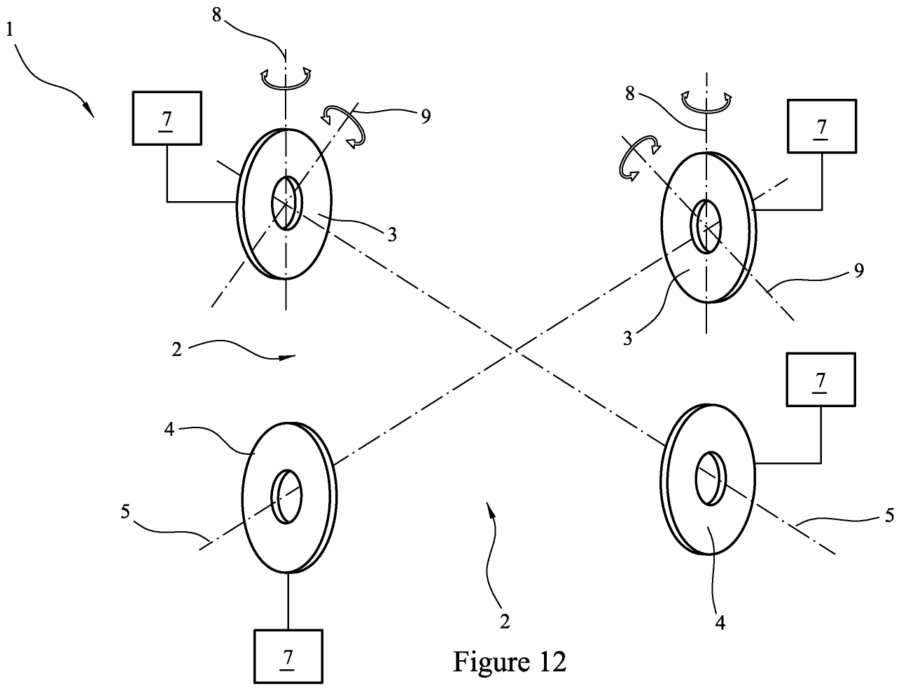

FIG. 12 shows a further embodiment of a spacecraft attitude control system according to the invention comprising a plurality of attitude control devices.

Shown in FIG. 1, in schematic form, is a first embodiment of a spacecraft attitude control system 1 according to the invention and which comprises a single attitude control device 2. The attitude control device 2 comprises first and second permanent magnets 3,4. Each permanent magnet 3,4 is a disk magnet. Each permanent magnet 3,4 comprises a north pole face and a south pole face and has a magnetic field extending between the two. The first magnet 3 has a magnetic moment M1 extending from its south pole face to its north pole face as shown. The second magnet 4 has a magnetic moment M2. In this embodiment the magnitude of M1 is equal to the magnitude of M2.

The first and second magnets 3,4 are spaced apart along a length axis 5 by a gap 6. Each magnet 3,4 has a closest pole face which is the pole face closest to the other magnet. The magnets 3,4 are arranged such that the closest faces are of the same pole as shown. An alternative way of expressing this is that the magnets 3,4 are arranged such that the magnetic moment for each magnet 3,4 extends in substantially the opposite direction to the magnetic moment of the other magnet 3,4.

The first magnet 3 is connected to a rotation mechanism 7. The rotation mechanism 7 is adapted to rotate the first magnet 3 about first and second axes 8,9. As can be seen none of the first axis 8, second axis 9 and magnetic moment M1 of the first magnet 3 are parallel to each other. In this particular embodiment the first axis 8 and second axis 9 lie in a plane which is normal to the length axis 5 and are normal to each other.

The second magnet 4 is held in fixed relation to the length axis 5. In this embodiment the magnetic moment M2 of the second magnet 4 extends along the length axis 5.

In use the spacecraft attitude control system 1 is attached to the body of a spacecraft. In FIG. 1 the spacecraft attitude control system 1 is shown in an initial configuration. In this configuration the magnetic moments M1 and M2 point directly towards each other along the length axis 5. When in this configuration if the spacecraft is exposed to an external uniform magnetic field then the torques of the two magnets 3,4 cancel each other out and to the spacecraft attitude control system 1 exerts no overall torque on the satellite.

As discussed above, when a spacecraft is exposed, to an external magnetic field this results in the spacecraft experiencing a torque which will cause the spacecraft to roll. In order to compensate for this the rotation mechanism 7 rotates the first magnet 3 about at least one of the first and second axes 8,9 to slightly misalign the magnetic moments M1 and M2. The torques on the first and second magnets 3,4 due to the external magnetic field no longer exactly cancel and so the spacecraft attitude control system 1 now exerts an overall torque on the spacecraft. By correctly aligning the first magnet 3 with respect to the second magnet 4 this overall torque can be arranged to cancel the torque on the spacecraft due to the external magnetic field so stabilising the spacecraft.

In alternative applications the spacecraft attitude control system 1 can cancel the torque on the spacecraft due to misalignment of magnetic components in the spacecraft. It can also be used to rotate the spacecraft to any desired orientation around the axis of the external magnetic field.

In the embodiment of FIG. 1 the magnets 3,4 are permanent disk magnets. The magnets 3,4 can be of other shapes. The magnets 3,4 could for example be rods, cubes or rhomboids. Other shapes of magnets 3,4 are possible. Typically, both magnets 3,4 are of the same shape although can be different shapes. The magnets 3,4 can be permanent magnets. Alternatively, they can be electromagnets.

Shown in FIG. 2 is an alternative embodiment of a spacecraft attitude control system 1 according to the invention. This embodiment is similar to that of FIG. 1 comprising a single attitude control device 2. However, in this embodiment the second magnet 4 is connected to a second rotation mechanism 7. The second rotation mechanism 7 is adapted to rotate the second magnet 4 about third and fourth axes 10,11 respectively. None of the third and fourth axes 10,11 and the second magnetic moment M2 are parallel. In this embodiment the third and fourth axes 10,11 lie in a plane normal to the length axis 5 and are normal to each other. In alternative embodiments the plane may be inclined to the length axis 5. In this embodiment the third axis 10 is parallel to the first axis 8 and the fourth axis 11 is parallel to the second axis 9 although in other embodiments they may be inclined to each other.

Shown in FIG. 3 is a further embodiment of a spacecraft attitude control system 1 according to the invention. Again, this is similar to the embodiment of FIG. 1 except in this embodiment the second magnet 4 is connected to a second rotation mechanism 7 adapted to rotate the second magnet 4 about a third axis 10 only. In this embodiment the third axis 10 lies in a plane normal to the length axis 5 although in alternative embodiments the plane may be inclined to the length axis 5. In this embodiment the third axis 10 is parallel to the first axis 8 although in alternative embodiments it may be inclined to the first axis 8.

Shown in FIG. 4 is a further embodiment of a spacecraft attitude control system 1 according to the invention. Again, this embodiment of a spacecraft attitude control system 1 comprises a single attitude control device 2. In this embodiment the first magnet 3 is connected to a first rotation mechanism 7 adapted to rotate the first magnet 3 about a first axis 8 only. The first axis 8 is inclined to the magnetic moment M1 of the first magnet 3. The second axis 9 is inclined to the magnetic moment M2 of the second magnet 4. in this embodiment both the first and second axes 8,9 lie in planes normal to the length axis 5 although in other embodiments one or both planes may be inclined to the length axis 5. The first and second axes 8,9 are not parallel when viewed along the length axis 5. In this embodiment one is normal to the other when viewed along the length axis 5. In use the two magnets 3,4 can be pivoted about their respective axes independently of each other to produce a torque in the desired direction.

A number of different rotation mechanisms 7 for producing rotation of an attached magnet about one or two axes are possible. The degree of rotation required may be (although is not necessarily) small such that the angle between the magnetic dipole moment of the magnet and the length axis is less than 25 degrees, more preferably less than 15 degrees, more preferably less than 10 degrees.

Shown in FIG. 5(a) is a first embodiment of a rotation mechanism 7 for rotating a magnet 3,4 about a single axis only for use with a spacecraft attitude control system 1 according to the invention. The rotation mechanism 7 comprises a single axis gimbal mechanism 12 which holds the magnet 3,4. FIG. 5(b) shows a variant of this and comprises an axle 13 attached to the magnet 3,4.

Shown in FIG. 6 is a further embodiment of a rotation mechanism 7 for rotating a magnet 3,4 about a single axis only for use with a spacecraft attitude control system 1 according to the invention. The rotation mechanism 7 comprises a support plate 14. Extending between the support plate 14 and magnet 3,4 are a pair of linear actuators 15. By extending one actuator 15 and contracting the other the magnet 3,4 can be rotated around the axis as shown.

Shown in FIG. 7 is an embodiment of a rotation mechanism 7 for rotating a magnet 3,4 about first and second axes 8,9 for use with a spacecraft attitude control system 1 according to the invention. The rotation mechanism 7 comprises a two-axis gimbal mechanism 16 which holds the magnet 3,4 as shown. The two axes of the gimbal mechanism 16 are aligned with the first and second axes 8,9.

Shown in FIG. 8 is a further embodiment of a rotation mechanism 7 for rotating a magnet 3,4 about first and second axes 8,9 for use with a spacecraft attitude control system 1 according to the invention. The rotation mechanism 7 comprises a support plate 14. The rotation mechanism 7 further comprises a plurality of linear actuators 15, preferably piezoelectric linear actuators extending between the support plate 14 and magnet 3,4 as shown. By extending one linear actuator 15 and contracting the opposite linear actuator 15 the magnet 3,4 can be made to rotate about an axis normal to a line passing through the two actuators 15. The support plate 14 is typically arranged in a plane normal to the length axis 5 although in alternative embodiments may be inclined to the length axis 5.

Shown in FIG. 9(a) is a further embodiment of a rotation mechanism 7 for rotating a magnet 3,4 about a first axis 8 only for use with a spacecraft attitude control system 1 according to the invention. The rotation mechanism 7 comprises a support plate 14. Pivotally connected to the support plate 14 is the magnet 3,4. The axis 8 of the pivot 17 is aligned with the first axis 8. The rotation mechanism 7 further comprises at least one (in this case two) linear actuators 15, typically a piezoelectric linear actuator extending between the support plate 14 and magnet 3,4 and spaced apart from the pivot 17. The linear actuators 15 are arranged such that extension or contraction of the linear actuators 15 causes the magnet 3,4 to, pivot at the pivot 17 and so rotate about the first axis 8.

As shown in FIG. 9(a) the support plate 14 is arranged normal to the length axis 5. As the magnet 3,4 is inclined to the support plate 14 the magnetic moment M of the magnet 3,4 is inclined to the length axis 5. In an alternative embodiment of the invention the support plate lies 14 in a plane inclined to the length axis 5 so that the magnet 3,4 can be pivoted to a position where its magnetic moment lies along the length axis 5 as shown in FIG. 9(b).

In a variant of the rotation mechanism 7 of FIGS. 9(a) and 9(b) the support plate 14 is adapted to rotate about the second axis 9 which passes through the support plate 14 normal to the support plate 14. The second axis 14 may extend along the length axis 5 or may be inclined thereto.

Shown in FIG. 10 is a further embodiment of a spacecraft attitude control system 1 according to the invention. The embodiment of FIG. 10 is similar to that of FIG. 1 and comprises a single attitude control device 2. The spacecraft attitude control system 1 further comprises a magnetometer 18 and a controller 19. The controller 19 is connected to the magnetometer 18 and rotation mechanism 7. In use the magnetometer 18 measures the magnetic field along at least one axis, more preferably along at least two axes, more preferably three axes. The measurement is passed to the controller 19. From this measurement the controller 19 determines the desired orientation of the first magnet 3 to cancel the effect of the external magnetic field and rotates the rotation mechanism 7 to bring the first magnet 3 to the desired orientation. If the rotation mechanism 7 is a gimbal mechanism 12,16 then the controller 19 comprises a motor which rotates the gimbal mechanism 12,16. If the rotation mechanism 7 comprises one or more piezoelectric actuators 15 then the controller 19 is adapted to provide the appropriate voltages to the piezoelectric actuators 15.

Shown in FIG. 11 is a further embodiment of a spacecraft attitude control system 1 according to the invention. This embodiment is similar to that of FIG. 10 except it further comprises a radiation shield 20 surrounding the first and second magnets 3,4 of the attitude control device 2. The radiation shield 20 comprises a plurality of shield magnets 21 arranged in a magnetic multipole such that in the absence of an external field the shield magnets 21 provide no overall dipole moment. The shield magnets 21 provide a shielding magnetic field which diverts ionising radiation away from the sensitive electronics on the spacecraft. In this embodiment the shield magnets 21 are arranged as a magnetic quadrupole. In alternative embodiments higher order multipoles are possible such as octopoles or hexapoles. As discussed above, these shield magnets 21 can become misaligned causing an unwanted magnetic torque on the spacecraft. The spacecraft attitude control system 1 according to the invention can correct for this.

Shown in FIG. 12 is a further embodiment of a spacecraft attitude control system 1 according to the invention. In this embodiment the spacecraft attitude control system 1 comprises first and second attitude control devices 2. Each attitude control device 2 is identical to the attitude control device 2 of FIG. 1 i.e. it comprises first and second magnets 3,4 spaced apart along a length axis 5 with the first magnet 3 adapted to rotate about two axes 8,9 and the second magnet 4 fixed. The two length axes 5 are normal to each other. Employing two attitude control devices 2 gives a greater degree of control over the orientation of the spacecraft in an external magnetic field.

In alternative embodiments of the invention one or both of the attitude control devices 2 of the system of FIG. 10 is replaced by an attitude control device 2 as shown in any of FIGS. 2 to 4.

In alternative embodiments of the invention the attitude control system 1 comprises a larger number N of attitude control devices 2. It could for example comprise 4, 8 or 16 attitude control devices 2. Typically N is even.

In further embodiments of the invention which comprise multiple attitude control devices 2 the length axes 5 of the attitude control devices 2 are inclined relative to each other at angles other than 90 degrees. The length axes 5 may or may not be coplanar.

1. A spacecraft attitude control system comprising:
at least one attitude control device, the attitude control device comprising:
first and second magnets having magnetic dipole moments M1 and M2 respectively, each magnet comprising a north pole face and a south pole face;
the magnets being spaced apart along a length axis by a gap,
for each magnet the pole face closest to the other magnet being termed the closest face, the magnets being arranged with the closest faces being of the same pole;
the first magnet being connected to a rotation mechanism, the rotation mechanism being adapted to rotate the first magnet about first and second axes, none of the first axis, second axis and magnetic dipole moment of the first magnet being parallel to the other.

2. A spacecraft attitude control system as claimed in claim 1 wherein the magnitude of M1 is equal to the magnitude of M2.

3. A spacecraft attitude control system as claimed in claim 1, wherein for each magnet the angle between its magnetic dipole moment and the length axis is less than 25 degrees, more preferably less than 15 degrees, more preferably less than 10 degrees.

4. A spacecraft attitude control system as claimed in claim 1, wherein the first and second axes are normal to each other.

5. A spacecraft attitude control system as claimed in claim 1, wherein the first and second axes lie in a plane normal to the length axis.

6. A spacecraft attitude control system as claimed in claim 1, wherein the rotation mechanism comprises a dual axis gimbal mechanism.

7. A spacecraft attitude control system as claimed in claim 1, wherein the rotation mechanism comprises a support plate spaced apart from the first magnet and a plurality of spaced apart linear actuators extending between the first magnet and support plate.

8. A spacecraft attitude control system as claimed in claim 1, wherein the rotation mechanism comprises:
a support plate, the magnet being pivotally connected to the support plate;
the support plate being adapted to rotate about the second axis;
the rotation mechanism further comprising at least one linear actuator extending between the support plate and magnet and spaced apart from the pivot, the at least one linear actuator being arranged such that extension or contraction of the linear actuator causes the magnet to pivot at the pivot and so rotate about the first axis.

9. A spacecraft attitude control system as claimed in claim 8 wherein the support plate lies in a plane substantially normal to the length axis and the second axis extends along the length axis.

10. A spacecraft attitude control system as claimed in claim 8 wherein the support plate lies in a plane inclined to the length axis and the second axis is inclined to the length axis.

11. A spacecraft attitude control system as claimed in claim 7, wherein at least one linear actuator is a piezoelectric linear actuator.

12. A spacecraft attitude control system as claimed in claim 1, wherein the second magnet is held in fixed relation to the length axis.

13. A spacecraft attitude control system as claimed in claim 12, wherein the magnetic moment M2 of the second magnet extends along the length axis.

14. A spacecraft attitude control system as claimed in claim 1, wherein the second magnet is connected to a second rotation mechanism, the second rotation mechanism being adapted to rotate the second magnet about third and fourth axes, none of the third axis, fourth axis and magnetic moment of the second magnet being parallel.

15. A spacecraft attitude control system as claimed in claim 1, wherein the second magnet is connected to a second rotation mechanism, the second rotation mechanism being adapted to rotate the second magnet about a single axis only.

16. A spacecraft attitude control system as claimed in claim 1, further comprising a magnetometer adapted to measure a magnetic field; and,
a controller connected to the magnetometer and at least one rotation mechanism and adapted to control the orientation of the at least one rotation mechanism in response to the magnetic field measured by the magnetometer.

17. A spacecraft attitude control system as claimed in claim 1, wherein at least one magnet is a rod.

18. A spacecraft attitude control system as claimed in claim 1, wherein at least one magnet is a disk.

19. A spacecraft attitude control system as claimed in claim 1, further comprising a radiation shield surrounding the first and second magnets.

20. A spacecraft attitude control system as claimed in claim 19 wherein the radiation shield comprises a plurality of shield magnets arranged in a magnetic multipole such that in the absence of an external magnetic field the shield magnets provide no overall dipole moment.

21. A spacecraft attitude control system comprising:
at least one attitude control device, the attitude control device comprising:
first and second magnets having magnetic dipole moments M1 and M2 respectively, each magnet comprising a north pole face and a south pole face;
the magnets being spaced apart along a length axis by a gap;
for each magnet the pole face closest to the other magnet being termed the closest face, the magnets being arranged with the closest faces being of the same pole;
the first magnet being connected to a first rotation mechanism, the first rotation mechanism being adapted to rotate the first magnet about a first axis not parallel to the first magnetic moment;
the second magnet being connected to a second rotation mechanism, the second rotation mechanism being adapted to rotate the second magnet about a second axis not parallel to the second magnetic moment; and
the first axis being not parallel to the second axis when viewed along the length axis.

22. A spacecraft attitude control system as claimed in claim 21, wherein the first and second axes lie in parallel planes.

23. A spacecraft attitude control system as claimed in claim 22, wherein the parallel planes are normal to the length axis.

24. A spacecraft attitude control system as claimed in claim 22, wherein the first and second axes are normal to each other when viewed along the length axis.

25. A spacecraft attitude control system as claimed in claim 21 wherein the magnitude of M1 is equal to the magnitude of M2.

26. A spacecraft attitude control system as claimed in claim 21 wherein for each magnet the angle between its magnetic dipole moment and the length axis is less than 25 degrees, more preferably less than 15 degrees, more preferably less than 10 degrees.

27. A spacecraft attitude control system as claimed in claim 21, wherein at least one rotation mechanism comprises a gimbal mechanism, preferably a single axis gimbal mechanism.

28. A spacecraft attitude control system as claimed in claim 21, wherein at least one rotation mechanism comprises an axle adapted to rotate about one axis only.

29. A spacecraft attitude control system as claimed in claim 21, wherein at least one rotation mechanism comprises a support plate spaced apart from its associated magnet and a plurality of spaced apart linear actuators extending between the magnet and support plate.

30. A spacecraft attitude control system as claimed in claim 21, wherein at least one rotation mechanism comprises a support plate, the associated magnet being pivotally connected to the support plate;
the rotation mechanism further comprising at least one linear actuator extending between the support plate and magnet and spaced apart from the pivot, the linear actuator being arranged such that extension or contraction of the linear actuator causes the magnet to pivot about the pivot.

31. A spacecraft attitude control system as claimed in claim 29, wherein at least one linear actuator is a piezoelectric actuator.

32. A spacecraft attitude control system as claimed in claim 21, further comprising a magnetometer adapted to measure a magnetic field; and,
a controller connected to the magnetometer and the rotation mechanisms and adapted to control the orientation of the rotation mechanisms in response to the magnetic field measured by the magnetometer.

33. A spacecraft attitude control system as claimed in claim 21, wherein at least one magnet is a rod.

34. A spacecraft attitude control system as claimed in claim 21, wherein at least one magnet is a disk.

35. A spacecraft attitude control system as claimed in claim 21 further comprising a radiation shield surrounding the first and second magnets.

36. A spacecraft attitude control system as claimed in claim 35 wherein the radiation shield comprises a plurality of shield magnets arranged in a magnetic multipole such that in the absence of an external magnetic field the shield magnets provide no overall dipole moment.

37. A spacecraft attitude control system as claimed in claim 1 comprising a plurality of attitude control devices, the length axis of at least one attitude control device being inclined, preferably normal, to the length axis of at least one other attitude control device.

38. A spacecraft attitude control system as claimed in claim 37, comprising first and second attitude control devices, the length axis of one being normal to the length axis of the other.

39. A spacecraft comprising a spacecraft attitude control system as claimed in claim 1.

40. A spacecraft as claimed in claim 39, wherein the spacecraft is a satellite.

41. A spacecraft attitude control system as claimed in claim 21 comprising a plurality of attitude control devices, the length axis of at least one attitude control device being inclined, preferably normal, to the length axis of at least one other attitude control device.

42. A spacecraft attitude control system as claimed in claim 41, comprising first and second attitude control devices, the length axis of one being normal to the length axis of the other.

43. A spacecraft comprising a spacecraft attitude control system as claimed in claim 21.

44. A spacecraft as claimed in claim 43, wherein the spacecraft is a satellite.
